(19) United States
(12) Patent Application Publication
(10) Pub. No.: US 2008/0203636 A1
(43) Pub. Date: Aug. 28, 2008

(54) Apparatus for holding disk-like objects

(75) Inventors: Rene Schenck, Jena (DE); Detlef Wolter, Jenapriessnitz (DE); Thomas Iffland, Jena (DE); Winfried Deutscher, Jena (DE)

Correspondence Address: Davidson, Davidson & Kappel, LLC, 485 7th Avenue, 14th Floor, New York, NY, 10018, US

(73) Assignee: VISTEC Semiconductor Systems Jena GmbH, Jena, DE (US)

(21) Appl. No.: 12/072,205

(22) Filed: Feb. 25, 2008

(30) Foreign Application Priority Data
Feb. 28, 2007 (DE) DE102007010224.2

(51) Int. Cl. B23Q 3/08; B25B 1/00; B25B 1/24

(52) U.S. Cl. 269/25; 269/156; 269/266

(57) ABSTRACT

An apparatus for holding disk-like objects, in particular semiconductor wafers (12), with at least three contacting elements (18) for supporting and/or fixing the disk-like object at its outer edge region (22). It is provided that at least one of the contacting elements (18) is moveable.

This claims priority of German Patent Application No. 10 2007 010 224.2, filed on Feb. 28, 2007, the entire disclosure of which is hereby incorporated by reference herein.

The present invention refers to an apparatus for holding disk-like objects, in particular semiconductor wafers.

### BACKGROUND OF THE INVENTION

German patent application laid open publication DE 196 01 708 A1 discloses a system for determining a position on a surface of an object. The object can be a semiconductor wafer, for example, which has a regular arrangement of essentially vertical grid lines on its surface and a plurality of directional features. The direction of the grid lines relative to the direction of a reference coordinate system can be determined with the aid of the system. A grid change associated with a directional change of the plurality of directional features can also be determined. The position of the change of direction is provided in the reference coordinate system. Using the apparatus, it is also possible to determine with reference to the directional features the distance of a feature from a geometric center of the surface.

### SUMMARY OF THE INVENTION

It is an object of the present invention to provide an apparatus for holding disk-like objects allowing secure and damage-free holding of the objects in a reliable manner and irrespective of the form of the edge of the object. The object is solved by an apparatus comprising at least three contacting elements for supporting and/or fixing the disk-like object at its outer edge region. At least one of the contacting elements is moveable and being arranged on a common frame. At least one moveable securing element reaches under the edge of the disk-like object and is at a distance to the latter, is arranged on the frame.

The present invention refers to an apparatus for holding disk-like objects, in particular semiconductor wafers, having at least three support elements for placing and/or fixing the disk-like object at its outer edge area. It is provided that at least one of the support elements is moveable, which has the advantage that the positioning of the support elements can be very precisely adjusted to the dimensions of each object to be held.

A common field of use of such apparatus is in an embodiment as a wafer receiving plate for receiving and holding a wafer above a scanner. To maintain the back of the wafer as completely free as possible for the scanner, the support surfaces on which the wafer is placed should only minimally cover the edge region. For this reason, the support elements of the apparatus according to the present invention are relatively small, which makes it necessary, however, to very precisely guide the objects or wafers to be received. At least one of the at least three support elements is made moveable so that tolerances in the outer dimensions can be compensated and/or the objects can be clamped and held with light pressure.

A preferred embodiment of the invention provides that the at least three support elements are arranged around the circumference of the disk-like object distributed over more than 180°. In this manner the object is prevented from being only unilaterally held, which would cause it to tilt and to fall out of the holding means in unfavorable conditions. In case three support elements are present the distance from one support element to the nest is 120°.

The support elements can be arranged on a common frame, for example, which could also be used for handling the disk-like object in a flexible manner. This frame can have a horse-shoe-like or u-shaped contour, for example, open on one side. The embodiment of the invention provides that the disk-like object can be fixed or clamped in the frame by means of at least one moveable support element. The support may be comprised of three support pins, for example, two of which are fixed, while the third is moveable. The moveable pin can be mounted, for example, on a pneumatically operated displacement unit. Of course, various other embodiments are also conceivable, for example, an electromotive drive of the moveable support element, a hydraulic drive, a linearly or rotationally moveable element etc. In the opened condition, the wafer or object to be held is placed on the three pins and is clamped between them by closing the cylinder.

Another embodiment of the invention provides that at least one moveable securing element is arranged on the frame, which reaches under the edge of the disk-like object at a small distance. Optionally, two or more moveable securing elements can also be provided, each reaching under the edge of the disk-like object at a small distance. These securing elements form a securing means to prevent the object or the wafer, etc. to be held from falling. To prevent the wafers or objects having dimensions at the lower limit of the tolerance range from falling past the support elements through the holder when they are placed in the latter, one, two, three or more additional support points are pivoted in, in addition to the support pins, as securing elements. In the pivoted-in state they are closer to the wafer center. These supports are suitably adjusted so that they are only a few tenths of millimeters below the wafer bottom surface and do not normally touch it. Preferably, the moveable securing elements are spatially associated with the support elements or arranged near them.

A further preferred embodiment of the invention provides that the moveable securing elements can be pivoted below the edge of the disk-like object when it is inserted and can be pivoted out of the engagement area of the object when the object is lying on the support elements. Should a disk-like object or wafer be placed on any of these points, it is shifted on its three support pins by closing the moveable pin due to the pin's edge geometry. After the wafer clamping is complete, the three pivoted-in supports are retracted away from the viewing area of the scanner.

Alternative embodiments of the invention can provide that the at least one moveable support element and/or the at least one movable securing element are displaceable and/or pivotable about an axis. The at least one moveable support element and/or the at least one moveable securing element can be activated, for example, mechanically, by an electric motor, hydraulically, pneumatically or in any other way.

A further preferred embodiment of the invention provides that the two or more moveable securing elements are coupled via connecting elements and can be activated by a common actuator. The two or more moveable securing elements can be coupled, for example, via coupling rods and/or via cables and can be activated by a common actuator. The coupling elements may optionally be above or below the level of the surface of the disk-like object. One example of an actuator is a double acting pneumatic cylinder. The transmission of the movement to the individual pawls or coupling links, can be above the wafer via coupling links, or below via cables. The advantage of the cable variant is that there are no moving parts above the wafer level. As a result, there is no contamination of the wafer surface if the air is properly guided in the mini environment.

The invention is not only for reliably holding disk-like objects, such as wafers or the like, but can also be used in an advantageous way for determining the center point of a wafer, irrespective of the form of the wafer edge. For this purpose, the wafer is first placed in a wafer holder. Herein, the edge of the wafer is pressed at least against three mechanical contacting elements, wherein the at least three contacting elements are distributed in such a way that the center point of the wafer is within a geometric form defined by the contacting elements. Then, each position of each contacting element is determined, and the geometric parameters of the wafers are calculated from the position of the contacting elements. The geometric parameters of a wafer can be, for example, its center point or the radius, or the diameter or the roundness of the wafer. Each of the contacting elements is formed as a pin, wherein the pin is provided with a marking or a through-hole. The position of each contacting element is determined by means of the marking, or the through-hole, from a bright-field or dark-field image. Herein, it is particularly advantageous if at least one of the contacting elements is provided with a position encoder, so that hereby the position of each contacting element can be determined. In addition to the at least three contacting elements, at least one mechanical sensor may be provided, allowing the roundness of the wafer to be determined.

A further embodiment of the invention can provide that at least one reference surface is arranged on the frame or on the wafer holder for calibration of the optical characteristics of an optical sensor means. A plurality of such reference surfaces may also be provided. These reference surfaces may be formed, for example, as recesses formed in the wafer holder, which are suitable to improve imaging. The reference surfaces are preferably of different materials, such as silicon or a suitable plastic material. They allow various information to be obtained on the illumination quality and the camera function for various illumination modes (bright-field, dark-field). The reference surfaces can be arranged at a plurality of positions in the image. The particular advantage of these fixedly positioned surfaces is that they allow long-term effects in the illumination or imaging to be evaluated and corrected without interfering influences due to varying characteristics of the wafers involved. The optical detection means (not shown), which can be calibrated with the aid of the reference surfaces, are usually for optically inspecting the wafer. In this context, usually the center point of the wafer to be inspected is determined with the apparatus according to the present invention, which may be done in a particularly precise and quick way using contacting elements.

### BRIEF DESCRIPTION OF THE DRAWINGS

The invention will be described in the following in an exemplary manner and with reference to the accompanying drawings. Further features, objects and advantages of the present invention will be derived from the accompanying drawings, in which:

FIG. 1 is a schematic view of an apparatus for holding a semiconductor wafer;

FIG. 2 is an enlarged view of the edge of the wafer;

FIG. 3 is a schematic plan view of a wafer holder provided with contacting elements and with additional securing elements;

FIG. 4 is another view of the wafer holder according to FIG. 3;

FIG. 5 is a schematic plan view of the wafer holder according to FIG. 3 with an inserted wafer;

FIG. 6 is a further view of the wafer holder according to FIG. 5;

FIG. 7 is a plan view of the back surface of the wafer holder according to FIG. 3;

FIG. 8 is a further view of the wafer holder according to FIG. 7;

FIG. 9 is a schematic perspective view of a portion of the wafer holder;

FIG. 10 is a plan view of the back surface of an alternative embodiment of a wafer holder; and

FIG. 11 is a schematic perspective view of the wafer holder according to FIG. 10.

### DETAILED DESCRIPTION OF THE INVENTION

In the figures identical reference numerals indicate identical or essentially equivalent elements or functional groups.

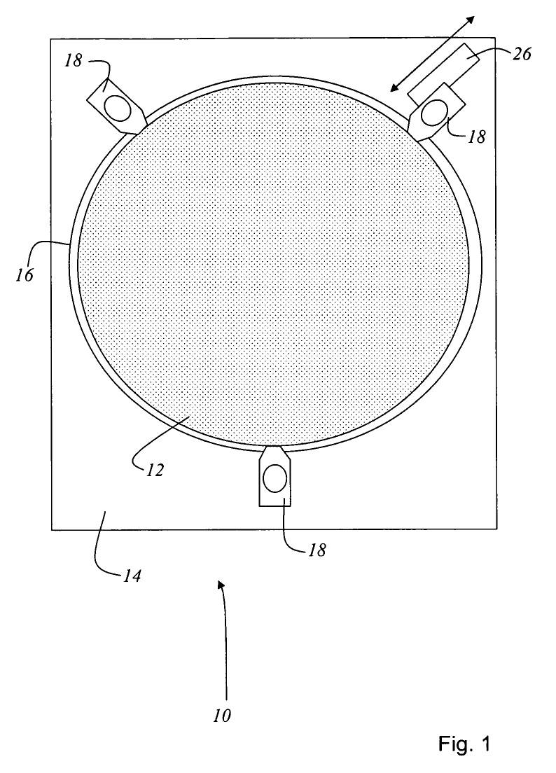

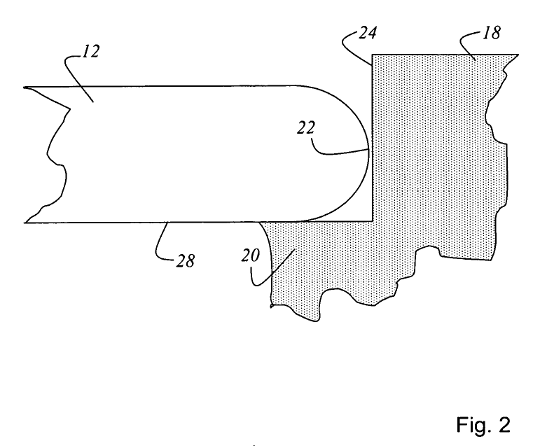

The schematic view of FIG. 1 illustrates one embodiment of an apparatus 10 according to the present invention for holding a disk-like object with reference to a semiconductor wafer 12. To determine the center point or other geometric parameters of a wafer 12 or for other handling steps, wafer 12 is inserted in a wafer holder 14. Wafer holder 14 has a circular opening 16 which is formed to be slightly larger than wafer 12 itself. In the embodiment shown, wafer holder 14 is provided with three contacting elements 18. It is obvious to a person skilled in the art that the number of contacting or support elements 18 shown here should not be construed as a limitation of the invention. It is also possible to use more than three contacting elements. Wafer 12 is inserted in opening 16 of wafer holder 14 and is supported on support elements 20 (cf. FIG. 2) of contacting element 18. To bring the edge 22 of wafer 12 into mechanical contact with contacting elements 18 or their stop surfaces 24 (cf. FIG. 2), at least one contacting element is configured to be moveable. Contacting element 18 can be moved along one traversing direction 26. Edge 22 of wafer 12 is brought into contact with the remaining contacting elements 18 by moveable contacting element 18. This is how a defined distance of contacting elements 18 to edge 22 of wafer 12, and therefore also a defined distance of contacting elements 18 to center point 28 of wafer 12, results from the position of contacting elements 18.

FIG. 2 is a schematic view of edge 22 of wafer 12. Edge 22 of wafer 12 is rounded. Sharp corners at the edge of a wafer are not envisaged. A contacting element 18 can also be seen, with which wafer 12 is mechanically held and contacted. Contacting element 18 comprises a supporting portion 20 and a stop surface 24. Wafer 12 with its edge 22, is in mechanical contact with stop surface 24 of contacting element 18. Supporting wafer 12 is ensured by a support element 20 provided on contacting elements 18 for contacting the flat portion 28 of wafer 12.

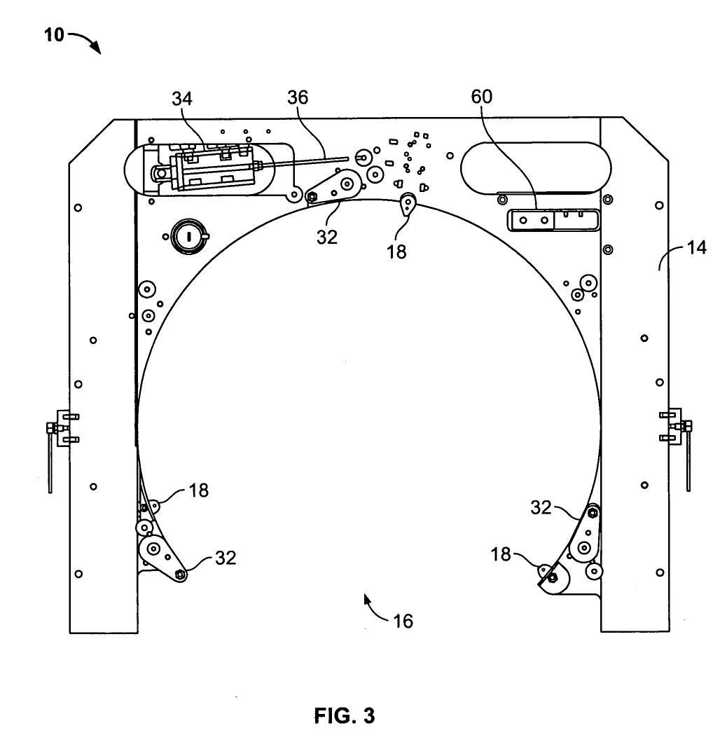

FIGS. 3 to 11, in schematic views, show various views and operational states of two embodiments of an apparatus 10 according to the present invention for holding a semiconductor wafer 12. Such apparatus are typically used for optical inspection, error inspection or the like with wafers 10, wherein it is important on the one hand that wafer 10 is securely fixed at all times, even when the apparatus is pivoted and rotated, for example. On the other hand, only the smallest possible surface area of the wafer back should be covered so as not to interfere with the optical inspection. For this reason the wafer should be supported on as few and as small support surfaces as possible.

Holding apparatus 10 shown in FIGS. 3 to 11 comprises a u-shaped or horseshoe-shaped, frame-like wafer holder 14, open on one side, to receive a wafer 12. Wafer holder 14 has a circular segment-shaped opening 16 which is configured to be slightly larger than wafer 12 itself. Three contacting elements 18 are provided on the inside of opening 16, which are distributed over an angular range of substantially more than 180°, to ensure reliable support of wafer 12. Wafer 12 is inserted in opening 16 of wafer holder 14 and is supported on support elements 20 (cf. FIG. 2) of each contacting element 18. Three additional securing elements in the form of pivoting brackets 32, which can each be pivoted between two end positions, are provided so that wafer 12 cannot jam or tilt, or fall out in the worst case. In a first end position they do not reach into opening 16, while in a second end position, after pivoting by a pivoting angle of about 60°-90°, they extend essentially radially from the edge into opening 16. In this second end position, each pivoting bracket 32 reaches under the inserted wafer 12; however, they do not touch it, but are arranged at a distance to the latter, so that only contacting elements 18 are in touching engagement. The distance is typically very small and can be in the range of a few hundredths or tenths of millimeters, for example.

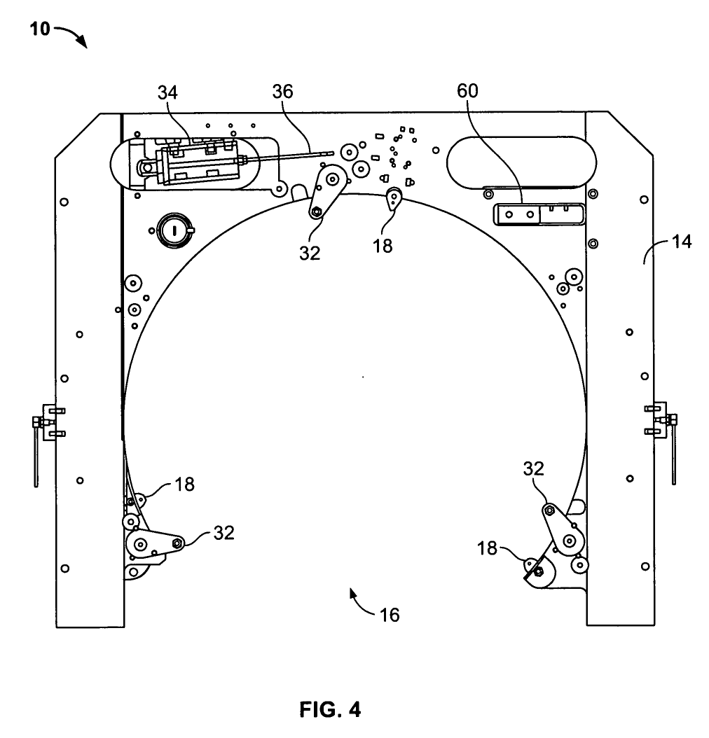

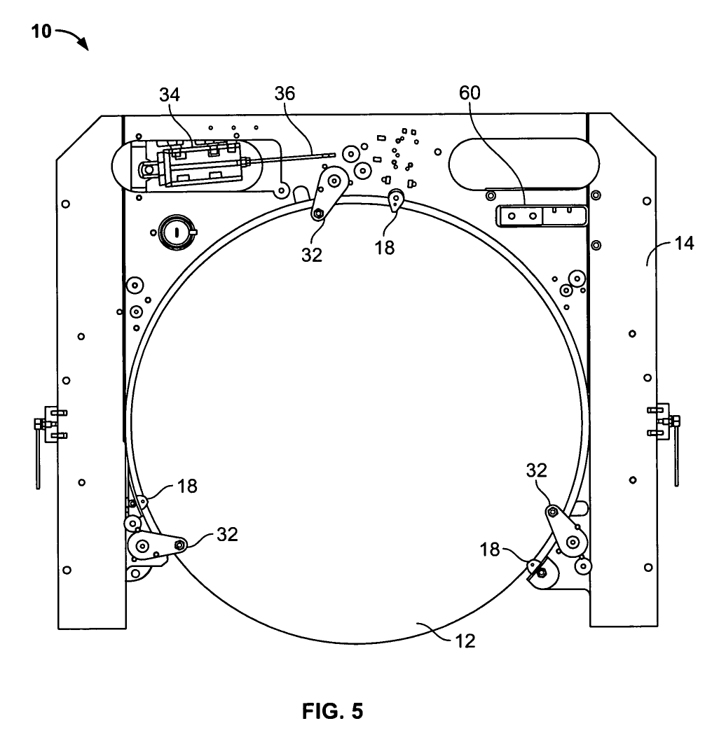

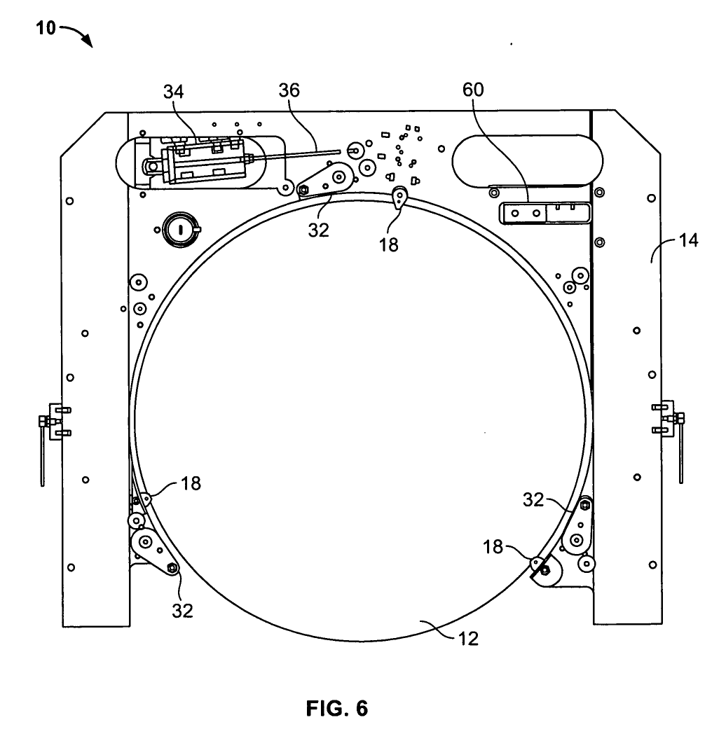

The schematic view of FIG. 3 shows pivoting brackets 32 in their first end position, which corresponds to a rest position, in which they do not protrude into opening 16. Only when a wafer 12 is to be inserted, pivoting brackets 32 are brought to their second end position (cf. FIG. 4), which they take to prevent wafer 12 from falling out. Then, a wafer 12 can be inserted in wafer holder 14 and fixed there by means of contacting elements 18 (cf. FIG. 5). In the ideal case, securing brackets 32 are not touched by wafer 12, but remain at a distance to the latter. Since securing brackets 32 can negatively affect the optical inspection of the wafer back due to their dimensions in their second end positions, they are retracted from its circumference area into their first end positions after wafer 12 has been successfully inserted (cf. FIG. 6). Wafer 12 can now pass through the predetermined optical inspection stations.

Pivoting brackets 32, in the exemplary embodiment shown, are always arranged near contacting elements 18, or are spatially associated with them. This is basically suitable, but not always necessary. The essential is, again, that wafer 12 is supported over an angular range of more than 120°, for the case when it is not precisely placed on the contacting elements and threatens to tilt or fall down. Pivoting brackets 32 are each activated and moved by a common pneumatic cylinder 34, which is arranged within the frame of wafer holder 14, for example, in a suitable recess, as shown in the figures.

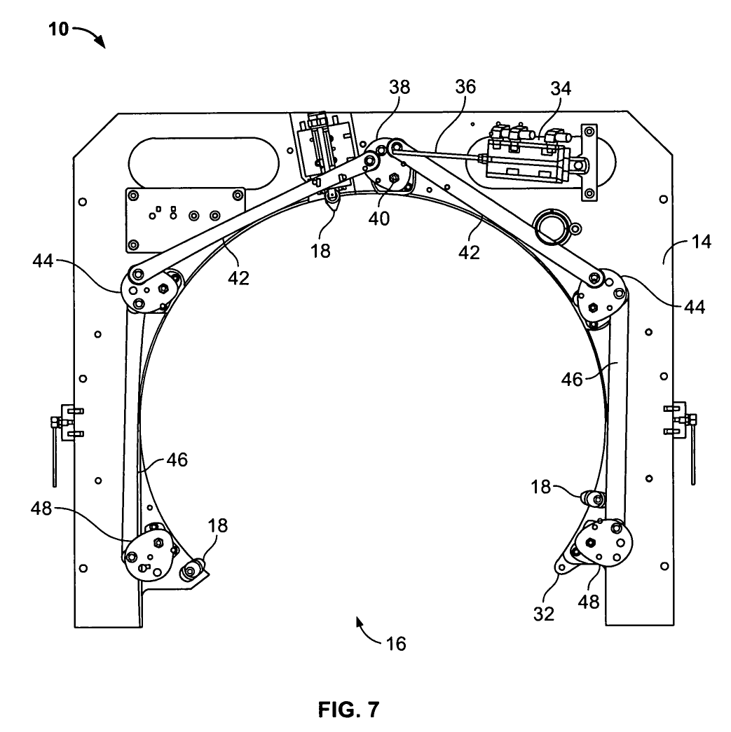

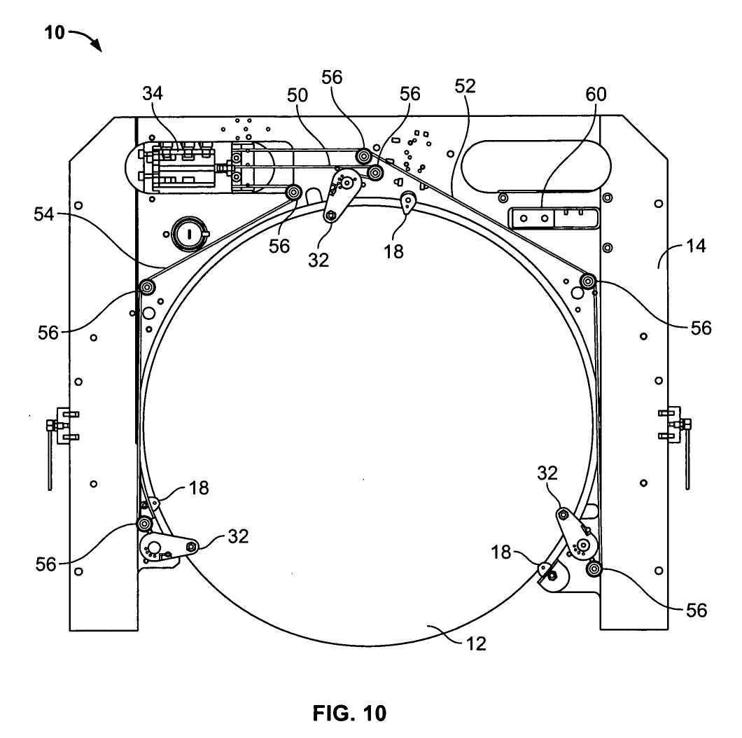

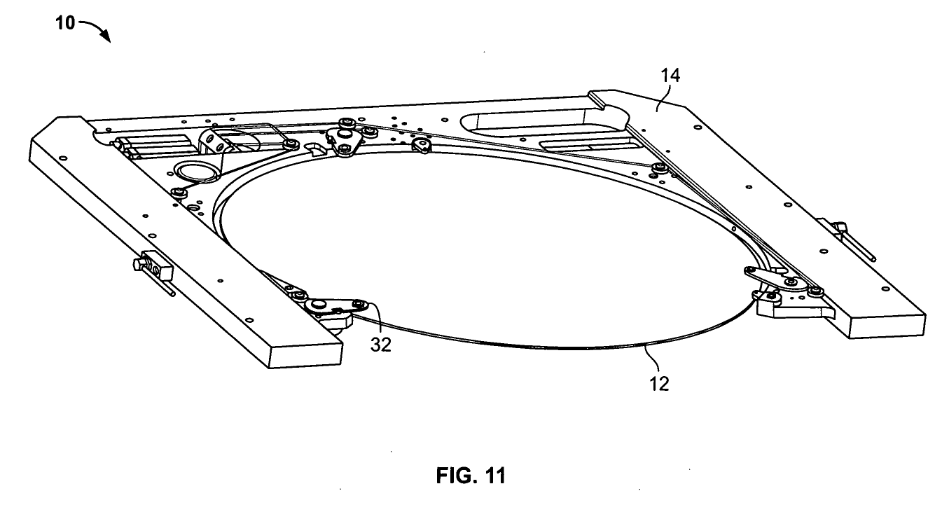

FIGS. 7 to 11 illustrate the mode of operation of activating the pivoting movement of pivoting brackets 32 between each of their end positions, wherein FIG. 3 to 9 illustrate a first embodiment, in which the pivoting brackets are mechanically activated by means of coupling rods and additional coupling links, while the adjustment in the second embodiment according to FIGS. 10 and 11 is carried out by means of redirected cables. In both variants the movements are initiated by means of pneumatic cylinder 34 which, in the first embodiment, comprises a piston rod or a thrusting rod, which cooperates with the coupling rods, while it actuates cables in the second embodiment. The coupling rods are in a plane above the wafer, while the cables extend below the wafer. The advantage of the embodiment using cables is in that there are no moving parts above the wafer level. This is why there is no contamination of the wafer surface if the air is properly guided in the mini environment.

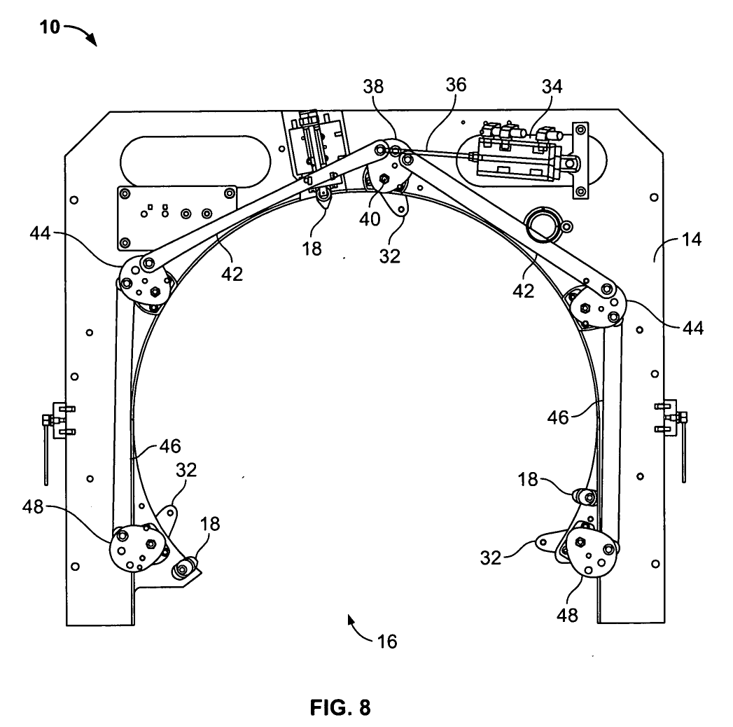

In the first embodiment (FIGS. 3 to 9), pneumatic cylinder 34 supported in frame 14 cooperates with a pivotably supported coupling disk 38 via a thrusting rod 36, wherein coupling disk 38 is fixedly connected with middle pivoting bracket 32 and defines its pivoting movement during a pivoting movement about an axle 40 supported in wafer holder 14. Two coupling rods 42 are linked on both sides of coupling disk 38 and are connected to further coupling disks 44, which are all supported on wafer holder 14 around the periphery of opening 16. These further coupling disks 44 are also provided with further coupling rods 46, for finally establishing the required effective link to the two other pivoting brackets 32, so that when pneumatic cylinder 34 is activated an essentially synchronous pivoting movement of all three pivoting brackets 32 by about the same pivoting angle can be ensured. The two further pivoting brackets 32 which are controlled via coupling rods 42 and 46 and via coupling disk 38 and coupling disks 44 are also fixedly provided with corresponding coupling disks 48, as can be seen from FIGS. 7 and 8.

In the schematic view of FIG. 7, central coupling disk 38, which cooperates with thrusting rod 36 of pneumatic cylinder 34, is pivoted to the left when thrusting rod 36 is extended to the left so that coupling rods 42 and 46 linked therewith and further coupling disks 44 and 48 coupled to the latter, are pivoted in the same direction. Pivoting bracket 32 is in its first resting position out of the engagement range with the wafer.

In the schematic view of FIG. 8, middle coupling disk 38 has been pivoted to the right with thrusting rod 36 also retracted to the right, so that coupling rods 42 and 46 linked therewith and coupling disks 44 and 48 coupled to the latter are pivoted in the same direction. Pivoting brackets 32 are then in their second end position within the engagement range with the wafer or below its outer edge, when it is inserted.

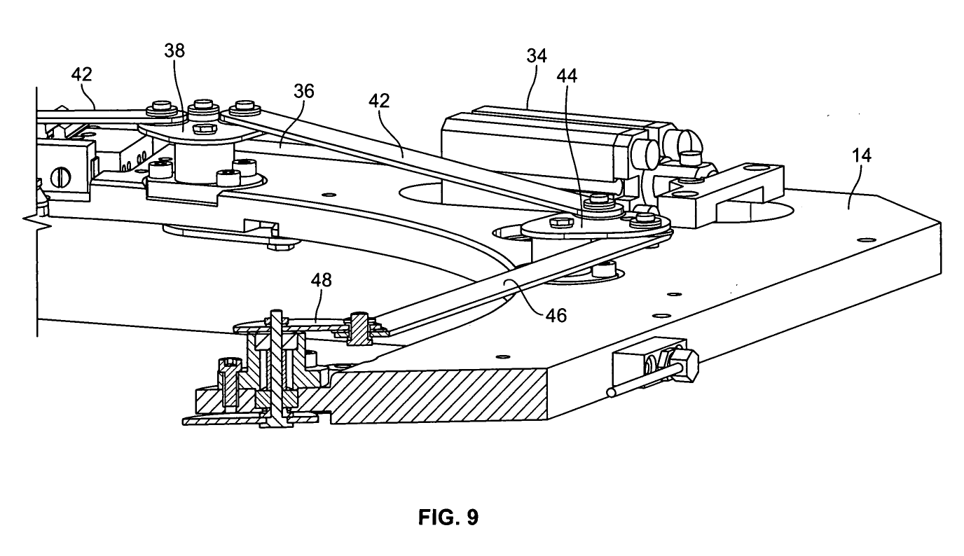

The schematic perspective view of FIG. 9 shows, in a detail, the cooperation of coupling disks 38, 44 and 48 and coupling rods 42 and 46 linked with them. The linkage of the parts with each other or in wafer holder 14 and the connection of the parts coupled with each other can be seen.

An alternative driving possibility for pivoting brackets 32 is illustrated with reference to FIGS. 10 and 11, which can be pivoted not via coupling rods but via redirected cables 50, 52 and 54. In this embodiment using cables, an overall more compact structure is possible, since the entire cable structure can be accommodated within a very flat plane. Pneumatic cylinder 34 is connected with three simultaneously moveable cables 50, 52 and 54, in this case, each coupled with one of pivoting brackets 32. By suitably redirecting the cables via one or more pulleys 56, pivoting of securing brackets 32 is carried out, which prevent tilting or falling down of wafer 12. Middle securing bracket 32 is actuated by a first cable 50, which is simply redirected via a pulley 56 in close proximity to securing bracket 32 to be pivoted, and is relatively short overall. Two outer securing brackets 32 are actuated via longer cables 52 and 54, which are each guided over three pulleys 56 in all. Pivotable securing brackets 32 are suitably equipped with return springs for return pivoting movement, as soon as pneumatic cylinder 34 no longer exerts tension on cables 50, 52 and 54. These return springs can be formed as helical torsion springs, for example, each arranged in the area of the pivoting axis of brackets 32.

Reference surfaces 60 in the form of recesses formed in wafer holder 14 can also be seen from FIGS. 3 to 6 and 10, which are necessary for imaging. These reference surfaces 60 are preferably of different materials, such as silicon or a suitable plastic material. They allow information on the illumination quality and camera function to be obtained for various illumination modes (bright-field, dark-field). Reference surfaces 60 can be arranged at various positions in the image such as in the top right corner of wafer holder 14, for example, as exemplarily shown in the figures mentioned. The particular advantage of the fixedly arranged surfaces 60 is in that long-term effects in the illumination or imaging can be evaluated and corrected without the attendant interfering influences due to varying characteristics of the wafers. An optical detector, which can be calibrated with the aid of reference surfaces 60, is usually used for optically inspecting the wafers. The apparatus according to the present invention in this context usually serves to determine the center point of the wafer to be inspected, which can be carried out by means of contacting elements 18 in a particularly precise and quick manner.

The invention has been described with reference to particular embodiments. It goes without saying for a person skilled in the art, however, that modifications and variations of the invention are possible without departing from the protective scope of the appended claims.

What is claimed is:

1. An apparatus for holding semiconductor wafers, comprising:
at least three contacting elements for supporting and/or fixing the disk-like object at an outer edge region of the disk-like object, at least one of the contacting elements being moveable and being arranged on a common frame, and at least one moveable securing element reaching under an edge of the disk-like object and being at a distance from the edge, being arranged on the frame.

2. The apparatus according to claim 1, wherein the at least three contacting elements are distributed over a circumferential range of the disk-like object of more than 180°.

3. The apparatus according to claim 1, wherein the disk-like object is fixable or clampable via the at least one moveable contacting element.

4. The apparatus according to claim 1, wherein the common frame has a unilaterally open or u-shaped contour.

5. The apparatus according to claim 1, wherein the at least one movable securing element includes two moveable securing elements reaching under the edge of the disk-like object and being at a distance from the edge.

6. The apparatus according to claim 5, wherein the moveable securing elements are spatially associated with the contacting elements or are arranged in close proximity to them.

7. The apparatus according to claim 5, wherein the moveable securing elements are pivotable under the edge of the disk-like object when inserted and are pivotable out of the engagement range of the object when the object is supported on the contacting elements.

8. The apparatus according to claim 1, wherein the at least one moveable contacting element and/or the at least one moveable securing element is displaceable and/or pivotable about an axis.

9. The apparatus according to claim 1, wherein the at least one moveable contacting element and/or the at least one moveable securing element can be activated mechanically, by an electric motor, hydraulically or pneumatically.

10. The apparatus according to claim 9, wherein the at least one movable securing element includes two or more moveable securing elements coupled via connecting elements and activatable by a common actuator.

11. The apparatus according to claim 9, wherein the at least one movable securing element includes two or more moveable securing elements coupled via coupling rods and/or via cables and activatable by a common actuator.

12. The apparatus according to claim 11, wherein the coupling rods and/or cables are arranged above or below the level of the surface of the disk-like object.

13. The apparatus according to claim 9, wherein the actuator is a double-acting pneumatic cylinder.

14. The apparatus according to claim 1, wherein at least one reference surface for calibrating the optical characteristics of an optical detector is arranged on the frame.
